(19) United States
(12) Patent Application Publication
(10) Pub. No.: US 2007/0196517 A1
(43) Pub. Date: Aug. 23, 2007

(54) Modified Saponin Molluscicide

(75) Inventor: Ricardo Manuel San Martin, Santiago (CL)

Correspondence Address: MYERS WOLIN, LLC, 100 HEADQUARTERS PLAZA, North Tower, 6th Floor, MORRISTOWN, NJ, 07960-6834, US

(73) Assignee: DICTUC S.A., Santiago (CL)

(21) Appl. No.: 11/740,275

(22) Filed: Apr. 25, 2007

Related U.S. Application Data
(63) Continuation-in-part of application No. PCT/US06/14458, filed on Apr. 18, 2006.

(30) Foreign Application Priority Data
Jul. 13, 2005 (CL) 1745-2005

(51) Int. Cl. A01N 45/00; A01N 65/00; A01N 43/04

(52) U.S. Cl. 424/725; 514/33; 514/26

(57) ABSTRACT

Saponins from plant materials are alkaline modified and used as molluscicides.

This disclosure is a continuation in part of pending PCT/US2006/014458 filed Apr. 18, 2006 and claims priority from Chilean application No. 1745-2005 filed Jul. 13, 2005, the entire disclosures of which are incorporated by reference herein.

### BACKGROUND OF THE INVENTION

1. Field of the Invention

This disclosure relates to the recovery of saponins from plant material. In particular, the invention relates to the recovery of saponins from Chenopodium quinoa (Quinoa) (Chenopodiaceae) husk in commercially useful forms. It also relates to a method and a composition based on quinoa saponins. The invention also relates to a method for the control of fresh water mollusks, in particular, snails, which comprises the application of a composition based on alkaline treated quinoa saponins, in which the dose results in the death of the mollusk but not in the death of non-target organisms, such as fish, frogs, etc., thus allowing the safe application of the method and product on flooded plantations such as rice fields, as well as in rivers, ponds, lakes and other naturally occurring or artificial bodies of water.

The composition comprises liquid and powders which do not attack beneficial forms of aquatic life when used in appropriate amounts. This disclosure also relates to methods of producing the disclosed compositions.

2. Description of Related Art

I. Snails

Snails are members of the molluscan class Gastropoda that have coiled shells. Snails are found in freshwater, saltwater, and terrestrial environments. Most are herbivorous, though a few land species and many marine species may be omnivores or carnivores. The majority of snails are not terrestrial. Snails with lungs belong to the group Pulmonata, while those with gills form a paraphyletic group.

Apple snails are tropical and sub-tropical freshwater snails of the family Ampullariidae (sometimes referred to as Pilidae). They are commonly divided into several genera. The genera Asolene, Felipponea, Marisa, and Pomacea are found in South America, Central America, the West Indies and the Southern U.S.A., while the genera Afropomus, Lanistes and Saulea are found in Africa. The genus Pila is native in both Africa and Asia.

Apple snails are the largest living freshwater snails. The Giant Apple Snail, Pomacea maculata (Family Ampullariidae), is the largest freshwater snail known, with a diameter of up to 15 cm and a mass of over 600 g. Apple snails are exceptionally well adapted to tropical regions characterized by periods of drought alternating with periods of high rainfall. One of the more typical adaptations of apple snails is the bronchial respiration system comparable with the gills of a fish located at the right side of the snail body which enables the snails to breathe under water as well as a lung at the left side of the body to respirate air.

Pomacea canaliculata is a common apple snail. In the 1980s, snails of the genus Pomacea (Pomacea canaliculata) were introduced in Taiwan to start an escargot industry and with the intent of providing a valuable protein source for farmers, who primarily live on a rice diet. It is now over 20 years since Golden Apple Snails (Pomacea canaliculata) were introduced in Asian countries from its native habitat in Northern Argentina and Southern Brazil with the intention of using them for human consumption. Unfortunately, the imported snails are able to transfer Angiostrongylus cantonensis (rat lungworm) like the native apple snail population (Pila). This parasite spends a part of its life cycle in apple snails and can infect humans when the snails aren't cooked thoroughly.

Instead of becoming a food source the snails escaped and became a serious threat to rice production and the environment. During the 1980s the introduced snails rapidly spread to Indonesia, Thailand, Cambodia, Hong Kong, southern China, Japan, the Philippines and Australia. In 1989 Pomacea canaliculata was introduced in Hawaii to serve as a food source and aquarium pet. Some snails escaped to the wild and turned into a serious pest in the taro and rice fields.

As a result of the failure this program, the snails were released to rivers and rice fields, where they proliferated to such an extent that they are now considered one of the 100 worst invasive alien species in the world (ISSG, 2006).

The Golden Apple Snail, popularly known as “golden kuhol” [Pomacea canaliculata Lamarck], is one of the major pest problems in rice production. In 1989, the Food and Agriculture Organization of the United Nations estimated that yield losses owing to this pest ranged from 1% to 40% of the planted area in the Philippines, resulting in a huge production loss (The Philippine Rice Research Institute).

Fresh water snails cause great losses in agriculture and health human problems. Since its introduction in Asia in 1985, the golden apple snail (Pomacea canaliculata) has caused losses in excess of US $1,000 million in rice crops. Likewise, there are several aquatic snails that transmit schistosomiasis (e.g. Biomphalaria spp.), which is, after malaria, the second most important tropical disease for humans, affecting more than 200 million people.

In the water of the rice fields the snails reproduce extremely quickly and eat young rice seedlings voraciously, causing significant economical damage to farmers. In addition to countries such as Taiwan, Thailand, Malaysia, Indonesia and The Philippines which are suffering from extensive damage due to this pest, other countries, such as Australia, consider the pest as a serious potential menace to its rice agriculture (Plant Health Australia, 2005, pp. 12-13).

The invasion of Pomacea in new habitats has been shown to drastically alter the state and function of invaded natural wetlands. When plants are consumed, nutrients in the system are shunted to phytoplankton instead of the plants which creates dense algal blooms.

Pomacea and Marisa species have been introduced in Africa and Asia to control snails such as Planorbidae, Bulinus sp. and Biomphalaria sp. which serve as intermediate hosts for trematoda parasites which can cause swimmers itch and schistosomiasis, a disease that affects over 200 million people in tropical regions. Despite the fact the tremadote parasites do not complete their life cycle in apple snails, apple snails themselves can carry these parasites and nematodes of the genus Angiostrongylus. Angiostrongylus cantonensis can afflict humans and cause eosinophilic meningoenchephalitis.

There are many species of apple snails, among which are Pomacea (Pomacea canaliculata, Lamarck, 1819) Bright Orange Pomacea (Pomacea insularum, D'Orbigny, 1839) Pink Pomacea (Pomacea lineata, Spix, 1827) Pink Pomacea (Pomacea doliodes, Reeve, 1856) Pink Pomacea (Pomacea haustrum, Reeve, 1856)and Green Pomacea (Pomacea gigas/maculata, Perry, 1810)

Newly-transplanted rice seedlings are vulnerable to golden apple snail damage for up to 15 days after transplanting or from 4 days to 30 days after sowing for direct-seeded rice. Golden apple snails devour the base of young seedlings. They may even consume the young plants in a whole paddy overnight.

The apple snail lays its eggs on any vegetation, leaves, and objects (e.g. twigs, stakes, stones, etc.) above the water surface. The eggs hatch in 7-14 days. The hatchlings are voracious feeders growing and maturing quickly. Golden apple snails reproduce rapidly, laying up to 1000-1200 eggs in a month.

They live in ponds, swamps, irrigated fields, canals and water-togged areas. Golden apple snails feed on a wide range of plants such as algae, azolla, duck weed, water hyacinth, rice seedlings, and other succulent leafy plants. The snails feed by scraping plant surface with its rough tongue so they prefer young soft plant parts.

Multiple attempts have been made to eradicate of invasive snails, in particular apple snails. Many farmers have resorted to the massive use of synthetic molluscicides that are expensive and broad spectrum, affecting non-target organisms including human beings.

II. Controls

There are few naturally occurring biological control agents. Red ants feed on the eggs; ducks eat the flesh and young snails. Techniques for managing apple snails include land preparation by handpicking golden apple snails from rice paddies, introducing plants that contain toxic substances against golden apple snails. Examples are gugo (bark) [Entada phaseikaudes K Meer], tubangkamisa (leaves), sambong (leaves) [Blumea balsamifera], tuba-tuba (leaves), gabihan (leaves) [Monochoria vaginalis], tobacco (leaves) [Nicotiana tabacum L], calamansi (leaves) [Citrus microcarpa Bunge], tubli (roots), makabuhay (leaves) [Tinospora rumphii Boerl], and red pepper (fruit).

Recommendations have included placing a wire or woven bamboo screen on the main irrigation water inlet and outlet to prevent the entry of hatchlings and adults and facilitate collection of trapped golden apple snails; utilizing bamboo stakes on water-logged areas in the paddies or near canals to attract adults for egg laying to facilitate hand collection and crushing of the egg masses easy; draining the rice field occasionally to limit snail mobility and feeding activity and herding ducks in rice paddies immediately after harvest to eat the snails

These techniques are highly labor intensive and are unsuited to many areas. In addition they are not highly effective in eradicating the snails. Thus, many farmers have turned to commercial molluscicides such as niclosamide and metaldehyde which are effective against golden apple snails that are directly hit. Their efficacy lasts 2-3 days. The synthetic chemical molluscicides typically used to control these snails are very expensive and extremely toxic to other living organisms and to the environment.

Niclosamide is a widely recommended compound for the control of the golden apple snail in rice fields (Pomacea spp). Niclosamide 250EC at half the label recommendation (0.5 1/ha) killed about 80% of the golden apple snails that were sprayed. Niclosamide kills more native snails than metaldehyde formulations. It is effective at doses from 0.5-1.0 mg/L (Bayer, 2005). However, the product kills 50% of tropical fish (LC₅₀) as carp when applied at a level of as low as 0.14 mg/L (World Health Organization, WHO 2002. WHO Specifications and Evaluations for Public Health pesticides, Niclosamide). This means that no fish must be in the rice fields while the product is applied nor must the water be discharged into the rivers or lakes nearby. Furthermore, the cost of niclosamide is US$ 40-80/hectare, which is unaffordable for many farmers.

III. Zebra Mussel and Other Mollusks

Saponins are effective in the control of golden apple snails members of the family Ampullariidae or Pilidae, part of Prosobranchia subclass.

Saponins also effectively control snails in the Planorbidae (Biomphalaria ssp and Isidorella ssp) and Lymnacidae (Lymnaea ssp) families, both part of Pulmonata subclass.

Control effects in the Bivalvia class (bivalves and clams) have also been reported, with respect to Blue mussel or Mytilus edilus, part of the Mytilidae family, subclass Pteriomorphia.

Saponins also control zebra mussel or Dreissena polymorpha, Dreissenoidea family, Heterodonta subclass. Since the arrival of the zebra mussel, a number of chemicals with previously known or newly discovered molluscicidal properties have been proposed for deployment against this highly invasive organism but none have been able to satisfy the requirement of an effective, selective, low cost material.

Zebra mussels are well adapted to water temperatures (12° C. to 32° C. (55° F. to 90°0 F.)), pH range (6.5 to >8), and turbidity levels that can be found in the Great Lakes and many U.S. riverine environments. Females release up to 30,000 planktonic (free-swimming) larvae, called veligers, which move with water currents and grow up to 1.3 cm (0.5 in.) in the first half year. These settle in colonies and attach to firm surfaces by means of secreted strands called byssal threads. Densities can reach 500,000 per square meter (46,500 or more per square foot), and individual life spans are 3 to 5 years. Zebra mussels are filter feeders, opening their shells to allow ingestion of particulates. When their sensitive chemoreceptors alert them to certain toxins in the environment, they have the ability to maintain shell closure for up to 2 weeks and thereby remain immune to certain biocide contact. Not all molluscicides evoke this response, however.

Chemicals identified for zebra mussel control have been derived mainly from water treatment compounds and antifouling biocides and biodispersants. Chlorine has been used for nearly a hundred years in drinking water disinfection, where its properties and behavior in effluent are well known, and it has been the primary chemical for zebra mussel control in Europe. In contrast, molluscicidal properties have been associated only recently with endothall, a compound used for several decades as an aquatic herbicide. Investigation of toxicity to both the target and nontarget organisms in the aquatic environment is the first step in the ongoing effort to identify more compounds that will be effective against zebra mussel. While oxidizers, and particularly the various forms of chlorine, continue to be the most commonly used of the chemical controls, additional compounds have been registered; and more continue to be tested in the search for environmentally sound and effective treatment of this pest.

The major types of oxidants frequently used for chemical control of biofouling and available as generic chemicals for molluscicide use are chlorine, chlorine dioxide, chloramines, such as monochloramine, ozone, hydrogen peroxide, bromine and permanganates such as potassium permanganate. In general they have similar modes of action based on the oxidation of organic matter, which leads to non-selective toxic and lethal effects. Oxidizers also present problems because of their corrosive effects on metals.

While chlorine dominates all chemical use for zebra mussels, there has been concern that there will be additional restrictions on its discharge in the future due to its nonselectivity and its formation of undesirable by-products such as trihalomethanes (THMs) and chloramines upon coming into contact with organic compounds in open water.

Most nonoxidizing molluscicides were originally developed for bacterial disinfection and algae control in water treatment systems and include organic film-forming antifouling compounds, gill membrane toxins, and nonorganics. The proprietary formulations have a higher per-volume cost than oxidizing chemicals but remain cost-effective due to lower use rates and rapid toxicity. They often can provide better control of adult mussels due to the inability of mussels to detect them; because shells remain open, shorter exposures are required. Most are easy to apply and do not present corrosion problems for metal components.

Numerous pesticide compounds have been suggested or investigated for zebra mussel control and are discussed in a variety of research and product information literature. However, most are currently not in common use, either because they are less effective on zebra mussels, harmful to native bivalves as well as zebra mussel and therefore limited to use in contained systems or have not yet been registered for zebra mussel control.

Some of the proposed compounds are Clonitralid (5-chloro-n-(2-chloro-4-nitrophenyl)-2-hydroxybenzamide compound with 2-aminoethanol (1:1) (9ci)); Niclosamide (Bayluscide 70) (2-aminoethanol salt of 2′,5-dichloro-4′,nitro-salicylanilide); Bayer 73 (Bayluscide) (2′,5-dichloro-4′,nitro-salicylanilide), zinc oxide: Rotenone (1,2,12,12a-tetrahydro-2-iso-propenyl 8,9-dimethoxy-[1]bensopyrano[3,4]furo [2,3-b][1]benzo pyran-6 (6aH) one): Salicylanilide I (Sal I) (2′,5-dichloro-3-tert-butyl-6-methyl-4′-nitrosalicylanilide); and TFM (Lamprecid) (3-trifluoromethyl-4-nitrophenol). A number of compounds derived from natural sources such as plant

toxins have been tested for use in controlling zebra mussels (Taylor and Zheng 1995, 1997). In addition, antibiotic materials excreted by other aquatic organisms to keep them free of biofouling are relatively common, and these are being investigated for their ability to prevent settling when applied as extracts or as a component in coatings. However, none of these has become commercially available. Compounds that are toxic to mussels are also potentially toxic to other life forms, and they must be tested and handled as carefully as other molluscicides.

One such natural compound, Endod, is a plant toxin product that includes chemicals called Lemmatoxins derived from the fruit of the African soap berry tree Phytolacca dodecandra. Two U.S. patents for its use as molluscicides have been awarded. Lemmatoxins have been shown to be lethal to zebra mussels at concentrations higher than 15 mg L⁻¹, while lower concentrations inhibited attachment and aggregation of adult mussels (Lemma et al. 1991; Lee, Lemma, and Bennett 1993). Toxicological studies have been done on nontarget mammals (Hietanen 1997).

However, there still exists a need for an effective, selective molluscicide effective against zebra mussels.

IV. Saponins

Saponins are glycosides of steroids, steroid alkaloids or triterpenes found in plants, especially in the plant skins where they form a waxy protective coating. There are two main types of saponins depending on the chemical structure of sapogenin: triterpenic saponins (where the sapogenin is a triterpene) and steroidal saponins (where the sapogenin is a steroid). A third type of saponin, the alkaloid saponins is sometimes identified as a separate class. The saponins dissolve in water to form a stable soapy froth thought to be due to their amphiphilic nature.

The triterpenoid saponins have an oleanane structure and one or more glycosides, the glycosides being bound to the triterpenoid at the 3 position and/or at the 28 position. Saponins are composed of a ring structure (the aglycone) to which is attached one or more sugar chains. The glycoside sugars found naturally in quinoa include arabinose, glucose, galactose, xylose and glucuronic acid. A sapogenin is the triterpenoid alone without glycosides attached at either the 3 or the 28 position.

The aglycone can be asteroid triterpenoid or a steroidalalkaloid and the number of sugars attached to the glycosidic bonds vary greatly.

Saponins are natural tensoactives present in many plants. One of their main properties is that they foam abundantly in aqueous solutions. They are also capable of permeating plant walls and microorganisms due to their association with sterols that are present in the cell membranes. Their chemical structure consists in a hydrophobic nucleus (sapogenin) to which sugar chains of hydrophilic nature are bound.

Saponins have been identified in Aloe, amaranth, asparagus (as protodioscin), chickweed, Bacopa monnieri, Chlorophytum species, Chlorogalum species, soap plants, Conkers/horse chestnuts, tuberous cucurbit species, digitalis (as digitonin), echinodermata, fenugreek, grape skin[1], gotu kola, Gypsophila (Baby's Breath), jiaogulan, liquorice, mullein, olives, panax (as ginsenoside), Quillaia saponaria (bois de Panama, a member of the Rosaceae family), quinoa, rambutan, soapberry and many other members of the family Sapindaceae, including buckeyes, Saponaria (Soapwort, Bouncing Betty), soybeans, Tribulus terrestris (as protodioscin), wild yam, yucca, and many other plants used in medicine or as food items.

The major industrial sources of steroidal and triterpenic saponins are Yucca shidigera and Quillaja saponaria Molina extracts.

The saponins from Quillaja saponaria are used in veterinary vaccines as adjuvant (e.g., foot-and-mouth disease vaccines). Saponins are also mild detergents and are used commercially as well as for research.

The biological and chemical activities of the saponins are directly related to the number of sugar chains bound to the sapogenin. Saponins with sapogenins that have two sugar chains are called bi-desmosidic saponins; those that have one sugar chain attached to the sapogenin are called mono-desmosidic saponins. Generally mono-desmosidic saponins show molluscicidal and fungal activity, while bi-desmosidic saponins have much lower activities. However, bi-desmosidic saponins have good tensoactive properties and produce abundant foam.

The high levels of saponins found in certain plants have long been thought to be responsible for the medicinal effects of some of these plants (Waller, G. R. and K. Yamasaki, Saponins used in Traditional and Modern Medicine, Advances in Experimental Medicine and Biology, Vol.404, 1996, New York: Plenum Press). The presence of high levels of saponins in the seeds of plants such as Quinoa (Chenopodium quinoa) has restricted the use of the human consumption of this grain.

The use of saponins for the control of aquatic snails is well known, especially at a laboratory level. The pioneer work of Hostettmann et al. (Hostettmann, K., Kizu, H. and Tomimori, T., 1982. Molluscicidal properties various saponins. Planta Medica, 44, 34-35), determined that the molluscicidal activity was mainly associated with mono-desmosidic saponins. This action is possibly related to saponin bonds to gill membranes, which causes an increase in the permeability and thus an important loss of physiological electrolytes (Hostettmann and Marston, 1995. Saponins. Cambridge University Press).

This molluscicidal activity has encouraged various studies since the 1980's for the characterization of existing saponins in vegetable species such as Phytolacca, Swartzia among others (Bore, C., Hostettmann, K., 1987. Molluscicidal Saponins from Swartzia madagascariensis DESVAUX. Helvetica Chimica Acta 70, 570-576. Dorzas A. C., Hostettmann, K., 1986. Further Saponins from Phytolacca dodecandra L'Herit. Helvetica Chimica Acta Vol 69 2038-2047. Dorzas A. C., Hostettmann, M., Hostettmann K., 1988. Molluscicidal Saponins from Sesbania sesban. Planta Medica, 225-227. Treyvaud V, Marston A, Wahyo D, Hostettmann K., 2000. Molluscicidal saponins from Phytolacca icosandra. Phytochemistry 55, 603-609).

The most important work relates to the use of Phytolacca dodecandra extracts in Africa (particularly Ethiopia), for the control of snails of Biomphalaria, Bulinus and Oncomelania genus, which transmit the schistosomiasis disease. This is the second most important disease in tropical countries, which affects over 200 million people. The P. dodecandra plant contains fruits (berry type) with 25% of saponins. The molluscicidal saponins are oleanolic acid glycosides and are active from 1.5 to 3 ppm. These saponins have been used for the control of snails that transmit schistosomiasis, but only in rural areas and in a craft way.

U.S. Pat. No. 6,649,182 describes a method of protecting plantules of rice against golden apple snails. For this purpose the roots of the plantules are impregnated with chemical molluscicides, as well as saponins extracted from the tea seed cake. The patent does not disclose the control of snails by the addition of saponins to the rice field water nor the use of partially hydrolyzed saponins.

Despite the fact that the control of aquatic fresh water snails with saponins is well known, until now there are no economical formulations that are effective and selective. This is probably due to the fact that saponins with high molluscicidal activity come from plants that are not commercially cultivated or have low saponin content, which increases the price of the product.

Another problem is that the molluscicidal saponins also are very toxic to non-target organisms such as fish. For instance, currently for the golden apple snail control in Asia, tea seed cake (a by product of tea seed oil production in China), that contains around 7% w/w of saponins is used. This product is very economical (US $ 0.35/kg, US $16-27/hectare) but like the chemical products its use is restricted because it is extremely toxic to fish and the environment at low does of 1-2 mg saponin/L.

Traditionally, the saponin content in plant extracts has been determined by bioassay or by GLC analysis of the sapogenins derived by hydrolysis of the saponins (Ridout et al., J. Sci. Food Agric. 54:165 (1991)).

V. Quinoa

Chenopodium quinoa (“Quinoa”) is a grain crop which has been cultivated in South America for a number of years. Many saponins have been characterized from Quinoa which have a single sugar at position 28, and between one and three sugars at position 3 of the aglycone.

Quinoa husk is the material obtained in a commercial mill used to de-husk quinoa for human consumption.

It is known that quinoa husks contain at least 16 different triterpenic saponins (Woldemichael and Wink, 2001). The main saponins are bidesmosidic glycosides of oleanolic acid, hederagenin and phytolaccagenic acid (Dini et al. 2001*; Woldemichael and Wink, 2001; Zhu et al. 2002). The type of saponin present is important, since saponins derived from oleanolic acid and hederagenin exhibit high molluscicidal activity (Hostettmann and Marston, 1995, p 261).

Quinoa husks represent about 8-12% w/w of the grain and are considered a by-product with no commercial value. The saponin content depends on the quinoa variety: so called “sweet” quinoas contain lower amounts of saponins than “bitter” quinoas. Bitter varieties show more resistance to pests and are more widely cultivated.

The saponins concentrate in the outer husk of the grain, which is removed prior to consumption, and is a by-product without commercial value. (Woldemichael, G. and Wink, M. 2001. Identification and biological activities of triterpenoid saponins from Chenopodium quinoa. J. Agric. Food Chem. 49: 2327-2332.). The husk contains a high content of the molluscicidal triterpenes oleanolic acid and hederagenin.

Quinoa husk has the following advantages: 1) low cost (it is a by-product); 2) abundant (it is found in Bolivia and Peru, and more recently in Chile); 3) high saponin content (25-30%); and 4) Quinoa saponins have recently been approved by the US Environmental Protection Agency for its use against pathogenic fungi, bacteria, and viral plant diseases (Saponins of Chenopodium quinoa. Biopesticides Registration Action Document PC Code 097094. U.S. Environmental Protection Agency. Office of Pesticide Programs. Biopesticides and Pollution Prevention Division, 2005). This facilitates registration of the product in other countries.

The production of extracts rich in saponins from quinoa husk utilizing various solvents has been studied. U.S. Pat. No. 6,355,249 reports saponin extraction yields of 20-25% w/w using ethanol/water mixtures. Furthermore, the patent describes the production of quinoa sapogenins by acid hydrolysis of the saponins. Studies carried out at Catholic University of Chile (Department of Chemical and Bioprocess Engineering) show that the aqueous extraction of the quinoa husk (variety Real, Bolivia) yields up to 55% of solids that can be extracted with a saponin content of 50-60% w/w. This represents 25-30% of saponins in the husk (Campos, C. 2003. Extraccion de Saponinas de la Cascara de Quinoa. B.S.c. Thesis, Faculty of Engineering, Catholic University of Chile).

Quinoa originates from the Andes region of South America where it was a staple grain in pre-Spanish Conquest times. Traditional use declined after the Spanish Conquest (Galwey, N. W., et al., Food Sci. Nutr, 42F:245, 1990) and cultivation and use of the grain was not widespread until a recent revival due to western interest in this crop as a high lysine, high protein grain for human consumption (De Bruin, A., J. Food Sci., 26:872, 1964). The principal obstacle to wider human consumption of this grain is the bitter taste of the saponin content of the grain. In traditional use, the saponin content of the grain was reduced to acceptable levels by washing the grain in running water. These saponins have been shown to be anti-nutritive in animal studies (Gee, J. M., et al., J. Sci. Food Agric., 63:201, 1993).

Since the revival of interest in Quinoa, a number of attempts have been made to devise practical methods to reduce the saponin content (Amaya-Farfan, J., et al., Removal of saponins from quinoa (Chenopodium quinoa Willd) grain by milling, 5th Int. Congr. Food Sci. Technol., Kyoto, Japan (1978); Gee, J. M., et al., J. Sci. Food Agric., 63:201,1993; Reichert, R. D., et al., Cereal Chem. 63:471, 1986; Galwey, N. W., et al., Food Sci. Nutr. 42F:245, 1990; Rios, M. L. T., et al., Arch Latinoamer Nutr. 28:253, 1978; Ridout, C. L., et al., J. Sci. Food Agric. 54:165, 1991), including combinations of milling and washing. In all cases the saponin rich fraction was considered to be a waste product and was discarded.

Many interesting physiological and pharmacological effects have been attributed to saponins and/or the corresponding sapogenins.

The chemical nature of the saponins found in quinoa has been the subject of several investigations (Mizui, F., et al. Chem. Pharm. Bull., 38:375 (1990)); however, the procedures used in these investigations for the recovery of the saponins are not practical and applicable for commercial scale for production. The studies of Mizui et al. (Mizui, F., et al. Chem. Pharm. Bull., 38:375 (1990)) and others have shown that the saponins found in quinoa are of the triterpene type.

The prior art for isolation of saponins from quinoa falls into two categories: a) an aqueous extraction route typically as described in Estrada et al., U.S. Pat. No. 5,597,807 and U.S. Pat. No. 5,688,772; and b) a more traditional hot alcohol solvent (Mizui, F., et al. Chem. Pharm. Bull., 36:1415 (1988); Mizui, F., et al. Chem. Pharm. Bull., 38:375 (1990). Estrada et al. U.S. Pat. No. 5,688,772 teaches that water extracts of quinoa (10 g of hulls extracted by 2×100 ml of water) contain all or most of the saponins present in quinoa. These extracts, used for their molluscicidal activity, are not selective in control and kill many desirable aquatic species at the levels required to kill the intended mollusks.

Therefore, there exists the need to develop a product which is effective for its intended use in controlling mollusks but is selective in its effect on non-target species.

In addition, there exists the need to develop new products, preferably natural products, with low cost and minimum environmental impact.

It is an object of this invention to provide a low cost product that has molluscicidal properties.

It is another object of this invention to provide a molluscicide that is selective in effect and does not harm aquatic species other than mollusks.

It is yet another object of this invention to provide a molluscicidal product whose use does not harm human beings or the environment.

### BRIEF SUMMARY OF THE INVENTION

This need for a selective molluscicide has been met by the present discovery of a method of modifying saponins. The present specification discloses techniques for the production of highly molluscicidal saponins from abundant and low cost raw materials.

In the present invention the use of saponins from the Andean quinea cereal (Chenopodium quinoa) is preferred and is used to control populations of fresh water snails, mussels and other mollusks.

Modified saponins were tested against GAS and non-target organisms, such as fish, at a laboratory scale. The tests were performed with saponins in their native state and also after treatment under alkaline conditions. Tests against GAS were also carried out in rice fields in Northern Argentina and The Philippines during 2005 and 2006.

A major advantage of the present invention is that the saponins modified according to the instant process have only a moderate toxicity to non-target organisms such as fish. This means that product concentrations that are lethal for the target species, such as snails, mussels or other mollusks are not lethal for fish. Thus the product is safe for its use in fresh water systems where fish or other forms of beneficial aquatic life are present.

### BRIEF DESCRIPTION OF THE DRAWINGS

FIG. 1 is a flow chart of the major processing steps for producing a powder product.

FIG. 2 is a flow chart of the major processing steps for producing a liquid product.

FIG. 3 is a flow chart of the example processing steps for producing a powder product.

FIG. 4 shows RP-HPLC chromatogram of quinoa saponins where FIG. 4a shows a chromatogram of crude aqueous extract, and

FIG. 4b is a chromatogram of aqueous extract purified with ultrafiltration membranes.

FIG. 5 shows RP-HPLC chromatograms of quinoa husks treated with NaOH.

### DETAILED DESCRIPTION OF THE INVENTION

The present disclosure describes a selective molluscicide that is able to kill mollusks in an aqueous environment while not harming non-mollusk species; methods of producing such a selective molluscicide and methods of utilizing such a molluscicide.

The molluscicide of the present invention utilizes a saponin containing plant material such as quinoa husk (Chenopodium quinoa) as a raw material. The quinoa raw material is treated to render the saponins present in the raw material more effective in their molluscicidal properties while at the same time diminishing or removing any detrimental effects the product may have on non-mollusk species. This is accomplished by treating the husks with alkali to increase the molluscicidal properties of the saponins.

The molluscicide of the present invention is utilized by introduction to the aqueous environment of the target species.

The product useful in the present invention is a composition containing as an active ingredient a modified saponin obtained by treatment of a natural source of saponins with an aqueous alkaline solution under conditions that modify a substantial proportion of the naturally occurring saponins to a form that is both more effective in suppressing or eradicating populations of target mollusk species and which is also selective in that it has a minimal effect on non-mollusk animals.

Many natural sources of saponins have been identified, including in Aloe, amaranth, asparagus (as protodioscin), chickweed, Bacopa monnieri, Chlorophytum species, Chlorogalum species, soap plants, Conkers/horse chestnuts, tuberous cucurbit species, digitalis (as digitonin), echinodermata, fenugreek, grape skin[1], gotu kola, Gypsophila (Baby's Breath), jiaogulan, liquorice, mullein, olives, panax (as ginsenoside), Quillaia saponaria (bois de Panama, member of the Rosaceae family), quinoa, rambutan, soapberry and many other members of the family Sapindaceae, including buckeyes, Saponaria (Soapwort, Bouncing Betty), soybeans, Tribulus terrestris (as protodioscin), wild yam, yucca.

The major industrial sources of steroidal and triterpenic saponins are Yucca shidigera and Quillaja saponaria Molina extracts.

Saponins sourced from quinoa hulls or husks are the preferred saponin source in the present invention.

Natural saponins have no effect or are of varying effectiveness in their extracted state and suffer from the problems of non-selectivity in that they kill significant numbers of non-target organisms. Thus, an ongoing problem has been to maintain or increase the effectiveness of the extracted saponins while at the same time minimizing detrimental effects on the environment and non-target species.

The naturally occurring saponins when processed according to the procedures disclosed herein overcame the existing problems with the use or the saponins of the prior art.

The modified saponin molluscicide of the present invention is useful to limit or eradicate populations of mollusks of various types.

In one embodiment, it is especially useful to control or eradicate populations of apple snails, especially golden apple snails.

In another embodiment it is useful in the control or eradication of zebra mussels.

Apple snails are only a small part of the snail species that inhabit bodies of water around the world. The method and product of the present invention may also be used to control or eradicate populations of other snails, fresh water snails and other mollusks.

The modified saponin containing molluscicides of the present invention are useful against organism of the Class Gastropoda and Class Bivalvia. More particularly, the modified saponin containing molluscicides of the present invention are effective against members of the following:

Class Gastropoda Subclass Pulmonata
Family Acroloxidae, genera Acroluxus, Pseudancylastrum
Family Lymnaeidae, subfamilies: Lancinea and Lymnaeinae, genera Fisherola, Lanx , Lymnea, Galba, Stagnicola, Radix, Lymnea, and other genera.
Family Physidae, genera Physa, Physella, Aplexa, Stenophysa Family Planorbidae, subfamilies Rhodacmeinae, Buliniae and Planorbinae, subfamily Buliniae three tribes: Bulinini genera: Bulinus, Indoplanorbis, Laevapex, Gundlachia; Physastrini genera: Glyptophysa, Physastra, Ameriana, Barnupia, Ferresia, Pettancyclus, Isidorella, Bayardella, Patelloplanorbis, Oppletora, Ancylastrum, Miratesta; Camproceratini genera: Helisoma, Planorbarius; subfamily Planorbinae of five tribes: Planorbulini genera Planorbula, Menetis, Promenetus, Planorbella; Biomphalariini genera Biomphalaria, Drepanotrema; Planorbini genera: Planorbis, Afrogyrus, Afrogyrorbis, Anisus, Bathyomphalus, Gyraulus, Choanomphalus; Segmentini genera: Segmentina, Hippeutis, Lentorbis, Polypylis, Helicorbis; Ancylini genus: Ancylus

Class Gastropoda Subclass Prosobranchia;
Family Thiaridae genera Aylacostoma, Cubaedomus, Dorissa, Fijidoma, Hemisinus, Melanatria, Melanoides, Pseudopotamis, Sermyla, Sermylasma, Thiara, Tylomelania.
Family Viviparidae, subfamily Viviparinae genera Viviparus, Tulatoma; subfamily Campelominae or Lioplacinae genera Campeloma, Lioplax; subfamily Bellamyinae genera Bellamyia, Cipangopaludina, Notopala.
Family Neritidae genera Clypeolum, Fluvionerita, Neritilia, Neritina, Septaria, Theodoxus.
Family Pilidae genera Afropomlus, Asolene, Felipponea, Lanistes, Marisa, Pila, Pomacea, Pomella, Saulea, Turbinicola

Class Bivalvia Subclass Pteriomorphia
Family Mytillidae
Class Bivalvia Subclass Heterodonta
Family Dreissenoides

Most particularity, the modified saponins are effective to control members of the subclass Prosobranchia Family Pilidae, genera Pila and Pomacea.

The preferred source of the saponin active component is quinoa husk (Chenopodium quinoa) but the saponins from other natural sources may also be used.

Quinoa husks are obtained as a byproduct of edible quinoa production where the saponin rich husk of the quinoa seed is removed from the seed to provide an edible product. The husks are a byproduct of quinoa production and thus are available at a low or even negative cost.

The extraction process of the invention is preferably carried out on a commercial variety or cultivar of quinoa using a dry (non-green) part, and most preferably a husk product obtained by dry de-hulling to remove seed coats from commercial quinoa grain. Quinoa husk is commercially available and inexpensive (virtually a waste product) resulting from the treatment of quinoa seed to form consumable flour. Quinoa husk is rich in saponins (the husk contains approximately 50 times more saponin than could be recovered by washing the whole grain or extracting ground seed) and can be obtained by dry milling of high saponin content quinoa. However, if desired, other (preferably not green) parts of the quinoa plant may be used as starting materials for the saponin extraction, e.g. whole seeds, ground seeds, seed coats or quinoa flour.

The husks are stripped from the quinoa seed by conventional means. The husks need not be pre-treated by physical or chemical means before use in the several embodiments of the present invention, although communitation by mechanical means to further reduce the particle size of the husks is a convenient method of reducing the extraction time. If reduction in particle size is desired it may be accomplished by any conventional means.

When ready for use, either as received or as further reduced in size, the husks are mixed with water in a vessel of convenient size and the mixture stirred to aid extraction of the saponins from the husks into the water.

The extraction step is carried out at a specified ratio of husk to water and for specified times and temperatures sufficient to extract the saponins from the husks.

Description of Processes and Usage Rates

The final product may be in dry or aqueous form. Depending on the form of the final product desired, the extraction parameters and additional stages differ.

Powder Type Product

In general, quinoa husks as acquired from the de-hulling procedure without any preliminary preparation are used for saponin extraction with water. The ratio of husks to water (weight/weight) is on the range of from about 1:1 to about 1:10, preferably in the range of from about 1:1 to about 1:7 most preferably in the range of from about 1:3 to about 1:5.

The extraction time is a function of both the temperature and the ratio of water to husks. In general, the extraction time is in the range of from about 0.1 to about 3 hours, preferably in the range of from about 0.5 to about 3 hours and most preferably in the range of from about 0.5 to about one hour.

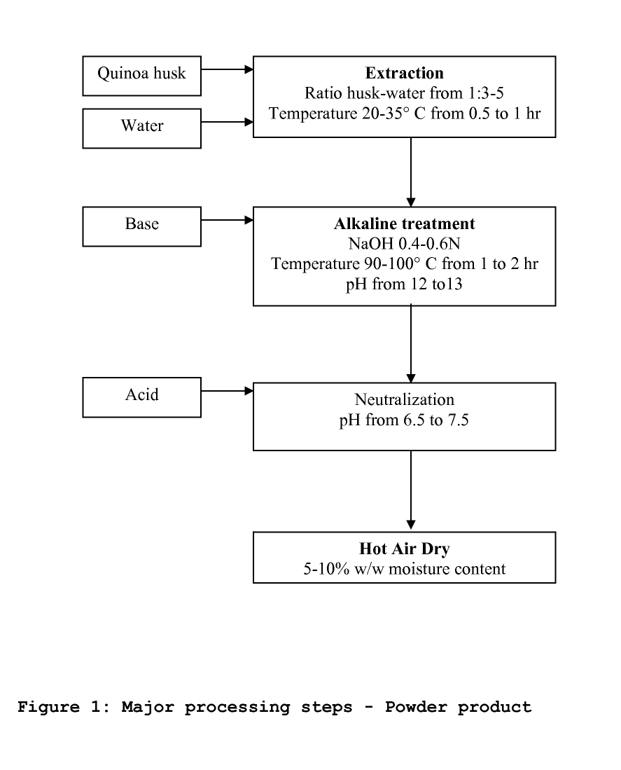

The temperature also affects the extraction time. In general the extraction may be carried out at ambient temperature but at a temperature in the range of from about 20 to about 90° C. has been found to be satisfactory with a temperature in the range of from about 20 to about 50° C. being preferable and a temperature in the range of from about 20 to about 35° C. being most preferable.

Where a powder type final product is desired, the flow sheet for the production process, including the most preferred process parameters, is shown in FIG. 1.

Extraction: where a powder type final product is desired the extraction parameters are shown in Table 1.

TABLE 1
Extraction parameters for powder type product

| | | | Most |
|---|---|---|---|
| Dry Product | Suitable | Preferred | Preferred |
| Ratio Quinoa/Water (w/w) | 1:1-10 | 1:1-7 | 1:3-5 |
| Temp (° C.) | 20-90 | 20-50 | 20-35 |
| Time (hrs) | 0.1-3 | 0.5-3 | 0.5-1 |

Alkaline treatment: the whole solution from the extraction step is treated with a basic reagent to modify the pH of the solution. Any convenient base may be utilized; sodium hydroxide is preferred. This basic reagent is added diluted in water so the ratio of husks to alkaline solution is in the range of 1:2. This makes a final solid to liquid ratio of about 1:5.

The concentration of the basic agent in the reaction mixture may vary from about 0.1 N to about 1 N. In particular, if the end product is to be a powder type product, the concentration is preferably in the range of from 0.3 N to 0.8 N, most preferably in the range of from about 0.4 N to about 0.6 N.

The pH of the solution is raised to a pH in the range of from about 8 to about 13, preferably to a range of from about 10 to about 13, most preferably in the range of from about 12 to about 13.

The alkaline aqueous solution is heated at temperature in the range of from about 50 to about 100° C., preferably to a temperature in the range of from about 70 to about 100° C., most preferably to a temperature in the range of from about 90 to about 100° C.

Heating of the basic aqueous solution generally continues for a period of from about 0.5 to about 3 hours, preferably for a period of from about 0.5 to about 2 hours, most preferably for a period of from about 1-2 hours. This alkaline treatment converts the native quinoa saponins to more hydrophobic saponin derivatives.

Where a powder type final product is desired the alkaline treatment parameters are shown in Table 2.

TABLE 2
Alkaline treatment parameters for powder type product

| Dry | | | Most |
|---|---|---|---|
| Product | Suitable | Preferred | Preferred |
| Base used | NaOH | NaOH | NaOH |
| | 0.1-1 N | 0.3-0.8 N | 0.4-0.6 N |
| pH | 8-13 | 10-13 | 12-13 |
| Temp (° C.) | 50-100 | 70-100 | 90-100 |
| Time (hrs) | 0.5-3 | 0.5-2 | 1-2 |

Neutralization: once the alkaline treatment is finished, the extract is cooled to room temperature and concentrated acid is added to bring the extract to a pH in the range of from about 3 to about 7.5, preferably in the range of from about 4 to about 7.5, most preferably to a pH in the range of from about 6.5 to about 7.5.

Drying: the extract is then dried with hot air to a moisture content of 5-10% w/w, followed by packaging.

Mollusk Control: This composition is useful in the control of fresh water snails and other mollusks. For the control of aquatic fresh water mollusks, the inventive product is added at product concentration from about 10 to about 40 ppm, most preferably from about 20 to about 35 ppm in the volume of water to be treated.

Liquid Type Product

In general, quinea husks as acquired from the de-hulling procedure without any preliminary preparation are used for saponin extraction with water. The ratio of husks to water (weight/weight) is on the range of from about 1:1 to about 1:15, preferably in the range of from about 1:5 to about 1:10 most preferably in the range of from about 1:8 to about 1:10.

The extraction time is a function of both the temperature and the ratio of water to husks. In general, the extraction time is in the range of from about 0.1 to about 3 hours, preferably in the range of from about 0.5 to about 3 hours and most preferably in the range of from about 0.5 to about one hour.

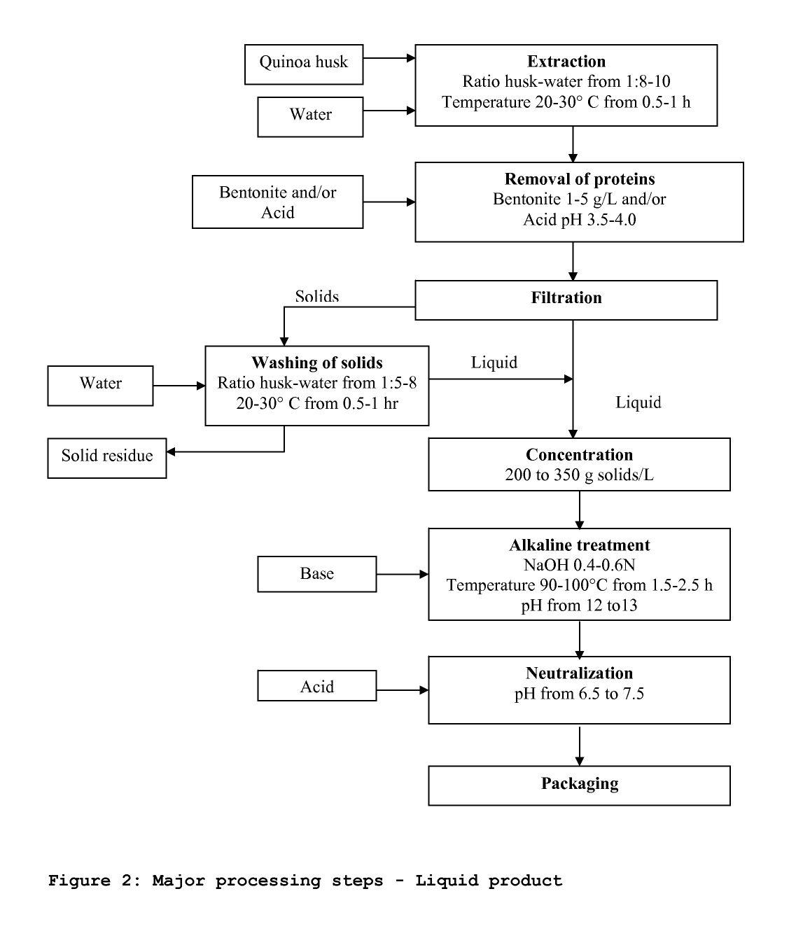

The temperature also affects the extraction time. In general the extraction may be carried out at ambient temperature but at a temperature in the range of from about 20 to about 100° C. has been found to be satisfactory with a temperature in the range of from about 20 to about 50° C. being preferable and a temperature in the range of from about 20 to about 30° C. being most preferable.

Where a liquid type final product is desired the flow sheet for the production process, including the most preferred process parameters is shown in FIG. 2.

Extraction: where a liquid final product is desired the extraction parameters are shown in Table 3.

TABLE 3
Extraction parameters for liquid type product

| | | | Most |
|---|---|---|---|
| Liquid Product | Suitable | Preferred | Preferred |
| Ratio Quinoa/Water (w/w) | 1:1-15 | 1:5-10 | 1:8-10 |
| Temp (° C.) | 20-100 | 20-50 | 20-30 |
| Time (hrs) | 0.1-3 | 0.5-3 | 0.5-1 |

Protein removal: following extraction, the whole mixture is treated with concentrated acid to precipitate any proteins present in the solution. This is accomplished by lowering the pH to 3 to 5, most preferable to pH 3.5 to 4, which corresponds to the isoelectric point of quinoa saponins. This produces the precipitation of an amorphous protein fraction. An alternative procedure considers adding bentonite to the solution, since this compound adsorbs proteins rendering them insoluble. It has also the incidental use of inducing more rapid clarification. Bentonite can be added at 1-10 g/L, most preferable at 1 to 5 g/L.

Removal of insoluble solids: following extraction and protein precipitation, the husks and the precipitated protein fraction are separated from the liquid extract by any conventional means, such as by decantation, filtration with or without the help of diatomaceous earth or other agent or centrifugation. This step must be done carefully so as to also remove the starch fraction present in the extract. These starch granules may produce gelatinization when the extract is further heated in the process (e.g. concentration by heat).

Washing of solids: the solid fraction remaining after solids removal may be re-extracted in a second extraction step to recover any residual saponins present in the occluded solution. For this, the solids are contacted with water under similar conditions to the initial extraction.

The second extraction step is conducted under the following conditions.

TABLE 4
Re-extraction parameters for liquid type product

| | | | Most |
|---|---|---|---|
| Liquid Product | Suitable | Preferred | Preferred |
| Ratio Quinoa/Water (w/w) | 1:1-15 | 1:5-10 | 1:5-8 |
| Temp (° C.) | 20-80 | 20-50 | 20-30 |
| Time (hrs) | 0.1-3 | 0.5-2 | 0.5-1 |

Once the second extraction is finished, the solids and extract are separated in the same manner as in the initial extraction. If desired, more than two extractions can be performed to further maximize saponin recovery. The parameters of such further extraction steps are equivalent to those of the second extraction step.

Industrially, multiple extractions can be performed using a counter-current multiple stage solid-liquid extraction equipment. Alternatively, if the filtration after the first extraction is performed in a conventional plate and frame filter equipment, fresh water can be used to wash residual saponins.

Concentration: the extract is optionally concentrated by heating at atmospheric or reduced pressure to obtain a final solids concentration in the range of 200 to 500 g solids/L, most preferably 200 to 350 g solids/L.

Alkaline Treatment: the liquid extract is treated with a basic reagent to modify the pH of the solution. Any convenient base may be utilized; sodium hydroxide is preferred. This basic reagent is added directly to the extract in a powder or liquid form.

The concentration of the basic agent in the reaction mixture may vary from about 0.1 N to about 1 N. In particular, if the end product is to be a liquid product, preferably in the range of from 0.3 N to 0.8 N, most preferably in the range of from about 0.4 N to about 0.6 N.

The pH of the solution is raised to a pH in the range of from about 8 to about 13, preferably to a range of from about 10 to about 13, most preferably in the range of from about 12 to about 13.

The alkaline aqueous solution is heated at temperature in the range of from about 50 to about 100° C., preferably to a temperature in the range of from about 70 to about 100° C., most preferably to a temperature in the range of from about 90 to about 100° C.

Heating of the basic aqueous solution generally continues for a period of from about 0.5 to about 3 hours, preferably for a period of from about 1 to about 3 hours, most preferably for a period of from about 1.5-2.5 hours. This alkaline treatment converts the present saponins to more hydrophobic saponins.

In particular, where the end product is to be a liquid product, the alkaline treatment parameters are shown in Table 5.

TABLE 5
Alkaline treatment parameters for liquid product

| Dry | | | Most |
|---|---|---|---|
| Product | Suitable | Preferred | Preferred |
| Base used | NaOH | NaOH | NaOH |
| | 0.1-1 N | 0.3-0.8 N | 0.4-0.6 N |
| pH | 8-13 | 10-13 | 12-13 |
| Temp (° C.) | 50-100 | 70-100 | 90-100 |
| Time (hrs) | 0.5-3 | 1-3 | 1.5-2.5 |

Neutralization: once the alkaline treatment is finished, the extract is cooled to room temperature and concentrated acid is added to bring the extract to a pH in the range of from about 3 to about 7.5, preferably in the range of from about 4 to about 7.5, most preferably to a pH in the range of from about 6.5 to about 7.5.

This extract is packaged and is ready for sale. In this phase, excipients or preservatives can also be added to improve its stability.

Mollusk Control: This composition is utilized to control fresh water snails or other mollusks. For the control of aquatic fresh water mollusks, the inventive product may be added at a solids concentration from about 10 to about 40 ppm, most preferably from about 20 to about 35 ppm, in the volume of water to be treated. Depending on the solid concentration of the final product (g solids/L), the amount of final product to be added may vary.

Determination of Saponins Concentration and Extent of Alkaline Treatment

A preferred method of estimating the saponin content utilizes reverse phase HPLC based on the method developed for Quillaja saponaria Molina triterpenic saponins (San Martin and Briones, 2000). This method can also used to assess the extent of the alkaline treatment, since the more hydrophobic saponin derivatives elute at longer retention times in the chromatogram. In RP-HPLC chromatograms, the non-treated quinoa saponins elute in the early part of the chromatogram. After alkaline treatment, these peaks weaken or disappear, and new peaks are formed at longer retention times (more hydrophobic compounds). The extent of the reaction can be monitored, by following the area of the remaining hydrophilic peaks. Complete reaction corresponds to almost complete disappearance of the hydrophilic peaks.

Effect of Alkaline Treatment

Previous papers describe that exposure of quinoa saponins (mainly bidesmosidic) to basic conditions causes a release of the glucose in carbon 28, resulting in a monodesmosidic saponin.

Surprisingly, we have now discovered that the conversion of bidesmosidic saponins to the monodesmosidic reported in the literature appear to occur to completion only in the presence of pure saponins. In the presence of multiple other components such as are present in crude aqueous saponin extracts obtained from natural sources, exposure to alkaline conditions results in a complex alteration of many of the salts, phenols, proteins, starch, fat and saponins present. It is the combination of the alteration in the structure of these multiple components that yields the synergistic effect demonstrated by the present product.

RP-HPLC analysis revealed that the saponin original present shows peaks in the hydrophilic part of the chromatogram (short retention times). After alkaline treatment, the saponin peaks shift from short retention times, to longer retention times. Almost all original saponin peaks disappear with 2 hours of exposure to alkaline conditions.

Samples of the original quinoa husks and the alkaline treated material may also be analyzed using LC/MS. This method allows the identification of saponin structures based on the molecular mass of each saponin.

The LC chromatogram has confirmed that after alkaline treatment, more hydrophobic saponin derivatives are formed

The MS analysis of the saponins in the raw material showed a combination of bidesmosidic, but also some monodesmosidic saponins, confirming existing literature reports. The main saponins are based on structures of oleanolic acid, phytolaccagenic acid and hederagenin.

However the analysis of the product surprisingly does not show lower molecular weight monodesmosidic saponins as would have been expected. On the contrary, the MS shows that the product contains a complex mixture of high molecular weight compounds. These compounds are derivatives of the original saponins. Instead of obtaining smaller compounds, it appears that some sugars and also unknown compounds attached to the original saponins.

During the alkaline treatment step a portion of the saponins are modified. The degree of modification may be measured by any convenient method.

The following non-limiting examples further illustrate the invention but do not define the full scope of the invention

### EXAMPLES

### Example 1

### Preparation of Powder Type Product and Saponin Analysis

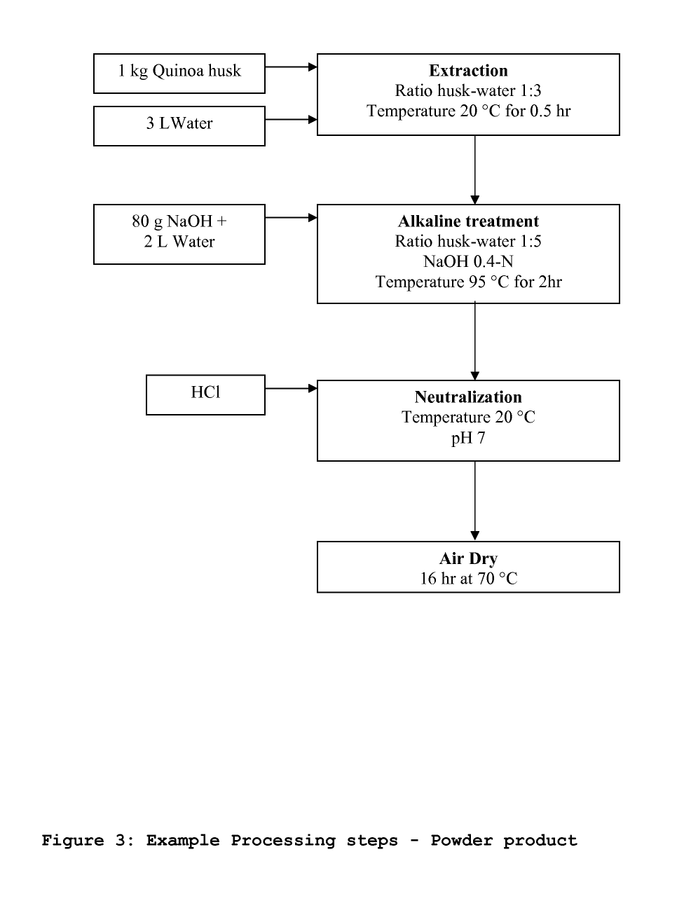

One kg of husks of quinoa real (origin: Bolivia) were contacted in a tank with 3 L of water. The mixture was stirred for 30 min at room temperature. Then 80 g of NaOH were dissolved in 2 L of water and added to the mixture. The final soda concentration was 0.4 N (80 g of soda in 5 L of water, molecular weight of NaOH: 40 g/gmol. This mixture was stirred at 95° C. for 2 hours. After completion of the reaction, the mixture was cooled at room temperature and neutralized with HCl (final pH 7.0).The mixture was air dried for 16 hours at 70° C. (see FIG. 3).

The saponin content in the raw material was estimated using reverse phase HPLC based on the method developed for Quillaja saponaria Molina triterpenic saponins (San Martin and Briones, 2000), using a Waters 600 equipment and UV detection at 210 nm. This analysis was also used to assess the extent of the alkaline treatment. Aqueous extracts for analysis were prepared by mixing 100 g of husks or product with 1 L of water for 2 h at room temperature and agitation, followed by filtration with Whatman # 2. The samples were injected at approximately 30 g soluble solids/L; the exact value was determined through drying at 70° C. until constant weight. The injection volume was 20 μL. In all chromatograms, saponins were considered to elute after 4 min, since non-saponin hydrophilic compounds (e.g. polyphenols) elute in the early part of the organic solvent gradient. Saponin content was estimated by comparing area of saponins in the sample to that of the standard containing 80% w/w saponins (see below):

% saponins (w/w): (A sample/A standard)×(Soluble solids standard/Soluble solids sample)×80%

The overall saponin content was thus estimated as:

% saponin (w/w): % saponin (w/w) in soluble solids×TSS

Total soluble solids (TSS) were estimated as the concentration of soluble solids in the filtrate (in g/L) times the total volume of water added (in L).

The standard was prepared by mixing 100 g of husks with 1 L of water at ambient temperature for 2 h. The extract was filtered through Whatman # 2 filtering paper. The filtrate (pH 5.7) was acidulated with concentrated HCl to pH 3.5, to obtain the isoelectric precipitation of quinoa proteins (Lindeboom, 2005), and filtered with the aid of 5 g/l of diatomaceous earth and Whatman #2. The extract was then dialfiltered with 8 volumes of distilled water, using 10 kDalton ultrafiltration membranes (Amicon, USA) to remove low molecular weight non-saponin impurities. Saponins are retained by the UF membranes due to their capacity to form micelles at concentrations above the critical micelle concentration. Since the proximal analysis showed the presence of 20% w/w non-saponin compounds (protein, fat, ash), the saponin content of the standard was estimated at approximately 80% w/w.

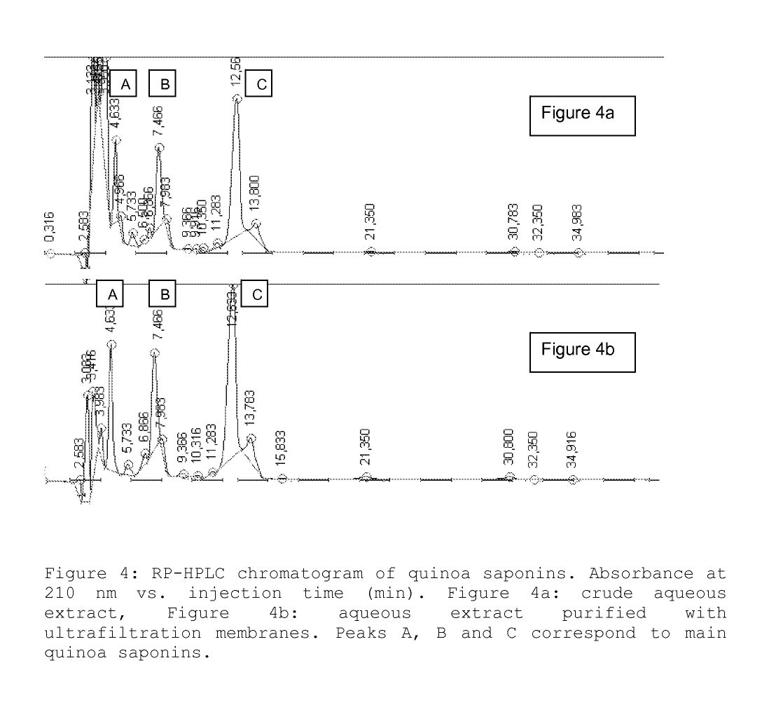

Product yield of 1.1 kg of dry product was obtained. The saponin content of the raw material, as well the extent of the alkaline reaction were estimated using RP-HPLC analysis. FIG. 4 shows RP-HPLC chromatograms of an aqueous extract of the raw material (FIG. 4a) and the purified sample used as standard (FIG. 4b). Both chromatograms are similar, except that for the standard the UV absorbing impurities that elute in the early part of the chromatogram have been reduced (e.g. elution time<4 min) due to diafiltration. Similar RP-HPLC chromatograms containing three main peaks (peaks A, B and C) have been reported for quinoa saponins (Muir et al. 2002). The proximal analysis of the standard revealed the presence of 20% w/w non-saponin compounds (ash, protein, fat). This was probably due to the entrapment of impurities in the saponin micelles and the partial loss of saponins through the membrane. These observations agree well with previous reports that indicate that quinoa samples treated with lower molecular weight cut-off UF membranes (e.g. 1000 kDalton) can achieve a higher saponin content, e.g. 85-90% w/w saponins (Muir et al. 2002). To estimate the saponin content of the raw material, 100 g quinoa husks were mixed with 1 L of water for 2 hours. An average of 55 g soluble solids/L was obtained, with a saponin content of approximately 52-53 % w/w. This did not change significantly with longer mixing time. Based on this, the saponin content of the quinoa husks used in laboratory experiments was estimated at 29 % w/w.

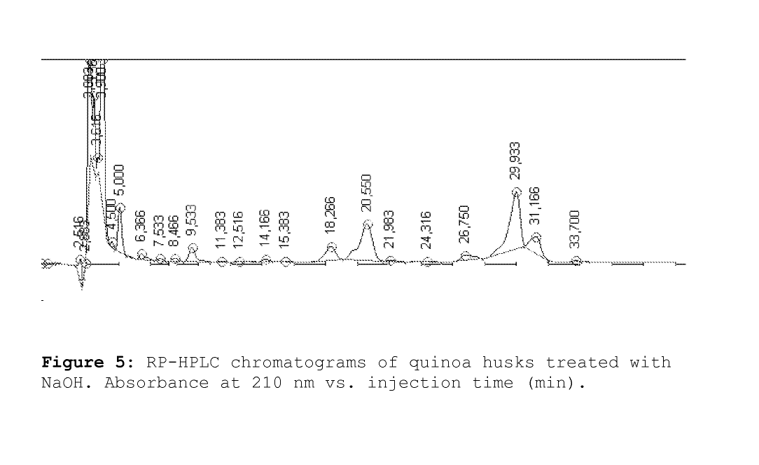

FIG. 5 shows the chromatogram of aqueous extracts of the raw material after treatment with NaOH for 2 hour. The chromatogram shows that the three major peaks present in the untreated samples disappeared almost completely and new peaks formed at longer elution times (more hydrophobic compounds). With shorter reaction times, a fraction of the three major original saponin peaks remained, indicating incomplete reaction (chromatograms not shown).

### Example 3

### Effect of Products on Golden Apple Snails and Fish

Product toxicology in snails was assessed with golden apple snails (Pomacea canaliculata) from Argentinean origin. Quinoa husks and the powder type product described in Example 1 was used. For this purpose, 20-35 mm adult snails were used. The snails were maintained in 25×20×15 cm. glass aquaria with lids. Each aquarium was filled with 2.5 L of tap water, previously treated with a chlorine neutralizing product. The snails were kept at about 22° C. using electrical heaters (3 Watt resistance). The pH was about 7.5. Before starting the tests, the snails were acclimatized to lab conditions for a week, receiving aquarium fish feed flakes every 12 h. Four snails were placed in each aquarium and each experiment was carried out in triplicate. Snail mortality was assessed by stimuli with a stainless steal needle and detection or lack of movement. After 24 h, snails classified as dead were placed in a separate container with fresh water and checked for recovery. Only those snails that did not recover within additional 24 h in fresh water were reported dead.

Product toxicology in fish was assessed in 2-3 g goldfish (Carassius auratus) using the products and the aquarium system previously described, except air pumps were added. This time 5 liters of water per aquarium were used at a temperature 16-18° C. Four fish were used in each aquarium and each experiment was carried out in triplicate. In some experiments 7-8 g tilapias (Oreochromis sp.) were used at 21-22° C. Every 24 h during 96 h, the number of dead fish per aquarium was recorded.

Table 6 shows the results of the experiments for the original quinoa husks and the powder type product tested against GAS and fish.

In the case of untreated quinoa husks, no dead snails or fish were observed even at the highest concentration tested (e.g.121 ppm of product). However, the alkali treated husks killed 100% of the snails at about 33 ppm. At this concentration, goldfish and tilapia did not die in 96 hours. In fact, no dead fish were observed even at the highest dose tested, e.g. 54 ppm product.

These results indicate that the composition based on alkaline treated husks is lethal for GAS at lower doses than for fish, making it possible to use it safely in rice fields. Another interesting observation is that the snails closed their operculum and ceased all movement almost immediately after the addition of 33 ppm of product. This probably allows for the protecetion of germinating seeds and young rice seedlings, reducing crop establishment losses in direct-seeded rice. Tests with husks treated with alkali for less than 2 h, or with lower NAOH or temperature conditions, were significantly less lethal to GAS (results not shown).

TABLE 6
Quinoa saponin toxicology in snails
and fish under laboratory conditions

| | | Snails | Goldfish | | | Tilapia fish | |
|---|---|---|---|---|---|---|---|
| | | % | % | % | % | % | % |
| | ppm | dead | dead | dead | dead | dead | dead |
| Product | product | 24 h | 24 h | 48 h | 96 h | 24 h | 96 h |
| Quinoa | 30 | 0% | 0% | 0% | 0% | | |
| husks | 45 | 0% | 0% | 0% | 0% | | |
| | 61 | 0% | 0% | 0% | 0% | | |
| | 76 | 0% | 0% | 0% | 0% | | |
| | 91 | 0% | 0% | 0% | 0% | | |
| | 121 | 0% | 0% | 0% | 0% | | |
| Quinoa | 5 | 0% | 0% | 0% | 0% | 0% | 0% |
| husks | 10 | 50% | 0% | 0% | 0% | 0% | 0% |
| treated | 17 | 75% | 0% | 0% | 0% | 0% | 0% |
| with | 23 | 75% | 0% | 0% | 0% | 0% | 0% |
| alkali | 33 | 100% | 0% | 0% | 0% | 0% | 0% |
| | 40 | 100% | 0% | 0% | 0% | 0% | 0% |
| | 54 | 100% | 0% | 0% | 0% | 0% | 0% |

I claim:

1. A particulate molluscicidal composition containing alkaline modified plant saponins obtained by a process comprising:
a) contacting a saponin containing plant material with water for a time sufficient to extract a portion of the saponins from the plant material,
b) adding a basic agent to alkaline modify the saponins present in the solution from step a),
c) reducing the pH of the solution from step b) to no greater than 7.5, and
d) drying the mixture of step c).

2. The composition of claim 1 where
step a) comprises contacting the saponin containing plant material with water in a ratio of 1 part by weight of plant material with from 1 to 10 parts by weight of water at a temperature from 20° to 90° C., from 0.1 to 3 hours,
step b)comprises adding sufficient basic agent to adjust the pH to a pH in the range of 8 to 13 while heating for 0.5 to 3 hours at a temperature from 50 to 1000 C, and
step c) comprises cooling the mixture of step b) to ambient temperature and reducing the pH to a pH in the range of 3 to 7.5.

3. The composition of claim 1 where the saponin containing plant material is at least one part of a quinoa plant.

4. The composition of claim 3 where the plant material is quinea husk.

5. A liquid molluscicidal composition comprising alkaline modified plant saponins, obtained by a process comprising
a) contacting a saponin containing plant material with water for a time sufficient to extract a portion of the saponins from the plant material,
b) removing soluble proteins from the extract,
c) separating insoluble materials from the liquid extract from step b) and recovering the extract,
d) optionally concentrating the extract recovered in c),
e) adding a basic agent to alkaline modify the saponins present in the extract from step d),
f) reducing the pH of the extract from step e) to no greater than 7.5, and
g) optionally adding excipients and/or preservatives.

6. The composition of claim 5 where
step a) comprises contacting the plant material with water at a ratio of 1 part by weight plant material to from 1 part to 15 parts by weight of water at a temperature from 20° to 100° C., for a period of from 0.1 hour to 3 hours,
step b) comprises removing soluble proteins from the extract by a method selected from adding acid in sufficient quantity to bring the pH to 3.5 to 4 to precipitate the proteins or by adding bentonite to the solution in the range of 1-5 g/L to adsorb the proteins,
step d) comprises concentrating the extract obtained in c) to a solids content of 200 to 500 g/L,
step e) comprises contacting the extracts of step d) with a sufficient quantity of a base to adjust the pH to a pH in the range of from 8 to 13 while simultaneously heating to a temperature in the range of from 50 to 100° C. to alkaline modify the extracted saponins, and
step f) comprises reducing the pH to a pH in the range of from 3 to 7.5.

7. The composition of claim 5 where the saponin containing plant material is at least one part of a quinoa plant.

8. The composition of claim 7 where the plant material is quinoa husk.

9. The composition of claim 5 where the insoluble materials from step c) are re-extracted at least one additional time, subject them again to step c) and the extracts are combined prior to step d).

10. A process for producing a particulate molluscicidal composition containing alkaline modified plant saponins comprising:
a) contacting a saponin containing plant material with water for a time sufficient to extract a portion of the saponins from the plant material,
b) adding a basic agent to alkaline modify the saponins present in the solution from step a),
c) reducing the pH of the solution from step b) to no greater than 7.5, and
d) drying the mixture of step c).

11. The process of claim 10 where
step a) comprises contacting the saponin containing plant material with water in a ratio of 1 part by weight of plant material with from 1 to 10 parts by weight of water at a temperature from 20° to 90° C., from 0.1 to 3 hours,
step b)comprises adding sufficient basic agent to adjust the pH to a pH in the range of 8 to 13 while heating for 0.5 to 3 hours at a temperature from 50 to 1000 C, and
step c) comprises cooling the mixture of step b) to ambient temperature and reducing the pH to a pH in the range of 3 to 7.5.

12. The process of claim 10 where the saponin containing plant material is at least one part of a quinoa plant.

13. The process of claim 12 where the plant material is quinoa husk.

14. A process for producing a liquid molluscicidal composition comprising alkaline modified plant saponins comprising
a) contacting a saponin containing plant material with water for a time sufficient to extract a portion of the saponins from the plant material,
b) removing soluble proteins from the extract,
c) separating insoluble materials from the liquid extract from step b) and recovering the extract,
d) optionally concentrating the extract recovered in c), ‘e) adding a basic agent to alkaline modify the saponins present in the extract from step c),
f) reducing the pH of the extract from step d) to no greater than 7.5, and
g) optionally adding excipients and/or preservatives.

15. The process of claim 14 where
step a) comprises contacting the plant material with water at a ratio of 1 part by weight plant material to from 1 part to 15 parts by weight of water at a temperature from 20° to 100° C., for a period of from 0.1 hour to 3 hours,
step b) comprises removing soluble proteins from the extract by a method selected from adding acid in sufficient quantity to bring the pH to 3.5 to 4 to precipitate the proteins or by adding bentonite to the solution in the range of 1-5 g/L to adsorb the proteins,
step d) comprises concentrating the extract obtained in c) to a solids content of 200 to 500 g/L,
step e) comprises contacting the extracts of step d) with a sufficient quantity of a base to adjust the pH to a pH in the range of from 8 to 13 while simultaneously heating to a temperature in the range of from 50 to 100° C. to alkaline modify the extracted saponins, and
step f) comprises reducing the pH to a pH in the range of from 3 to 7.5.

16. The process of claim 15 where the saponin containing plant material is at least one part of a quinoa plant.

17. The process of claim 16 where the plant material is quinoa husk.

18. The process of claim 14 where the insoluble materials from step c) are re-extracted at least one additional time, subject them again to step c) and the extracts combined prior to step d).

19. A method of controlling fresh water mollusks comprising applying a molluscicidal effective amount of a composition of claim 1 to a body of fresh water where such fresh water mollusks are found.

20. The method of claim 19 where the fresh water mollusks are members of the subclass Prosobranchia, family Pilidae.

21. The method of claim 20 where the fresh water mollusks are members of the genera Pila and Pomacea.

22. The method of claim 20 where the fresh water mollusks are apple snails.

23. A method according to claim 19, where the fresh water snails are selected from Pomacea ssp, Isidorella ssp, Biomphalaria ssp, Lymnaea spp.

24. A method according to claim 23, where the fresh water snails are of the species Pomacea canaliculata.

25. The method of claim 19 where the fresh water mollusks are zebra mussels.

26. A method according to claim 19, where the body of fresh water is selected from flooded plantations, rivers, ponds, fish farms and lakes.

27. A method according to claim 19, where the effective amount is 20-35 ppm alkali treated quinoa solids in the water to be treated.

28. A method according to claim 19 where the body of fresh water is a fish farm shrimp farm or rice paddy.

29. A method of controlling fresh water mollusks comprising applying a molluscicidal effective amount of a composition of claim 5 to a body of fresh water where such fresh water mollusks are found.

30. The method of claim 29 where the fresh water mollusks are members of the subclass Prosobranchia, family Pilidae.

31. The method of claim 30 where the fresh water mollusks are members of the genera Pila and Pomacea.

32. The method of claim 30 where the fresh water mollusks are apple snails.

33. A method according to claim 29, where the fresh water snails are selected from Pomacea ssp, Isidorella ssp, Biomphalaria ssp, Lymnaea spp.

34. A method according to claim 33, where the fresh water snails are of the species Pomacea canaliculata.

35. The method of claim 29 where the fresh water mollusks are zebra mussels.

36. A method according to claim 29, where the body of fresh water is selected from flooded plantations, rivers, ponds, fish farms and lakes.

37. A method according to claim 29, wherein the effective amount is 20-35 ppm of alkali treated quinoa solids in the water to be treated.

38. A method according to claim 29, where the liquid composition comprises from 200 to 500 g/L of alkaline modified quinoa solids and an excipient.

39. A method according to claim 29 where the body of fresh water is a fish farm shrimp farm or rice paddy.
